(19) United States
(12) Patent Application Publication
(10) Pub. No.: US 2005/0135977 A1
(43) Pub. Date: Jun. 23, 2005

(54) Multi-part catalyst system for exhaust treatment elements

(75) Inventors: Paul Worn Park, Peoria, IL (US); Carrie L. Boyer, Shiloh, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/739,323

(22) Filed: Dec. 19, 2003

(51) Int. Cl. F01N 3/28; B01D 53/34

(52) U.S. Cl. 422/180; 422/177; 502/439

(57) ABSTRACT

An exhaust treatment element may include a substrate and a first catalyst layer including a first promoter disposed on the substrate. The exhaust treatment element may also include a second catalyst layer including a second promoter disposed on the first catalyst layer. In addition to a multi-layer catalyst, the exhaust treatment element may include a series catalyst system where a first and second catalyst are disposed in separate regions along the length of the substrate.

### TECHNICAL FIELD

This invention relates generally to catalytic exhaust treatment elements and, more particularly, to catalytic exhaust treatment elements that include multi-part catalyst systems.

### BACKGROUND

Internal combustion engines can produce exhaust streams that include various gases and combustion products. Some of these gases, such as nitrogen oxide gases (NOx) including, for example, nitrogen monoxide (NO) and nitrogen dioxide (NO₂), can contribute to environmental pollution in the form of acid rain and other undesirable effects. As a result, many regulations have been imposed on engine manufacturers in an attempt to reduce the levels of NOx emitted into the atmosphere.

NOx removal from the exhaust streams of lean burn engines can be especially challenging. Lean burn engines, which may include diesel engines as well as certain spark ignited engines, may operate with an excess of oxygen. Specifically, in a lean burn engine, more oxygen may be supplied to the engine than is necessary to stoichiometrically consume the fuel admitted to the engine. As a result, the exhaust streams of these lean burn engines may be rich in oxygen, which can limit the available techniques suitable for NOx removal.

To reduce the NOx concentrations in the exhaust stream of lean burning engines, a number of lean-NOx catalysts have been developed that may selectively reduce NOx in oxygen rich exhaust streams with hydrocarbon reductants. These lean-NOx catalytic systems may depend on the presence of sufficient levels of hydrocarbon species to be fully effective. The amount of hydrocarbons available in the exhaust streams of many lean burning engines can be low. Therefore, in some applications including as active catalytic systems, a hydrocarbon compound such as diesel fuel, for example, may be introduced into the exhaust stream in order to promote reduction of NOx compounds.

Several lean-NOx catalysts have been developed that include alumina in some form. Alumina is known as a durable material, and it has shown promise as a catalyst for lean-NOx reactions at high temperatures. Nevertheless, even alumina-based catalysts have proven problematic. For example, many catalysts or catalytic systems that have been used with lean burn engines suffer from low NOx conversion efficiencies, inadequate catalyst durability, low thermal stability, narrow effective temperature ranges, and NOx selectivity limited to only certain compounds.

In an attempt to address the shortcomings of lean-NOx catalysts, various catalyst configurations and compositions have been proposed. For example, U.S. Pat. No. 6,284,211 (“the '211 patent”) describes a multi-component NOx-reducing catalyst that includes a silver oxide-based catalyst formed on one part of an exhaust gas cleaner and a tungsten and/or vanadium oxide-based catalyst formed on another part of the exhaust gas cleaner. Despite its multi-component catalyst, the exhaust gas cleaner of the '211 patent may still suffer from one or more problems including low NOx conversion efficiencies, inadequate catalyst durability, low thermal stability, narrow effective temperature ranges, and NOx selectivity limited to only certain compounds.

### SUMMARY OF THE INVENTION

One aspect of the present invention includes an exhaust treatment element that has a substrate and a first catalyst layer including a first promoter disposed on the substrate. The exhaust treatment element may also have a second catalyst layer including a second promoter disposed on the first catalyst layer.

A second aspect of the present invention includes a method of making an exhaust treatment element including supplying a substrate and forming a first catalyst layer including a first promoter on the substrate. A second catalyst layer including a second promoter may be formed on the first catalyst layer.

### BRIEF DESCRIPTION OF THE DRAWINGS

FIG. 1 is a schematic illustration of an exhaust treatment system according to an exemplary embodiment of the present invention.

FIG. 2 is a pictorial representation of an exhaust treatment element according to an exemplary embodiment of the invention.

FIG. 3 is a diagrammatic partial cross-sectional representation of an exhaust treatment element including a single layer catalyst according to an exemplary embodiment of the invention.

FIG. 4 is a diagrammatic partial cross-sectional representation of an exhaust treatment element including a multi-layer catalyst according to an exemplary embodiment of the invention.

FIG. 5 is a graph that plots NOx conversion percentage as a function of temperature for various exhaust treatment elements in an exhaust stream containing NO.

FIG. 6 is a graph that plots NOx conversion percentage as a function of temperature for various exhaust treatment elements in an exhaust stream containing NO₂.

### DETAILED DESCRIPTION

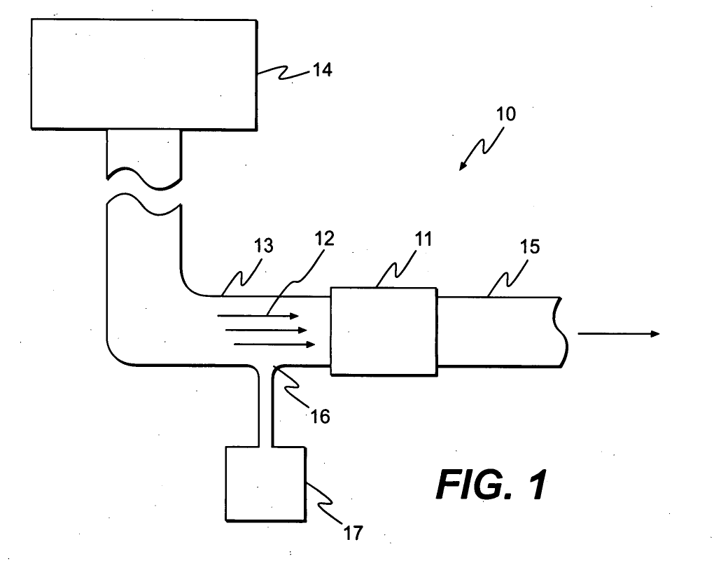

FIG. 1 illustrates an exemplary exhaust system 10 that may include an exhaust treatment element 11 for treating an exhaust stream 12 transferred through exhaust conduit 13. In one embodiment of the invention, exhaust stream 12 may be produced by a lean burn internal combustion engine 14, which may be a diesel engine, a spark ignited engine, or any other type of engine that may be operated with an excess of oxygen. Further, engine 14 may operate in either a stationary role (e.g., power plants, generators, etc.) or in a mobile capacity (e.g., vehicles, moving equipment, etc.). As a common trait of many lean burn engines, the excess oxygen present during combustion may yield NOx in the exhaust stream. Exhaust treatment element 11 may be provided in system 10 to convert at least some of the NOx from exhaust stream 12 into more benign compounds such as nitrogen gas (N₂), carbon dioxide, and water vapor, for example. These compounds may then be expelled into the atmosphere through an exhaust conduit 15. Exhaust system 10 may also include a reservoir 17 for housing a supplemental reductant that may be added to exhaust stream 12 through fluid inlet 16.

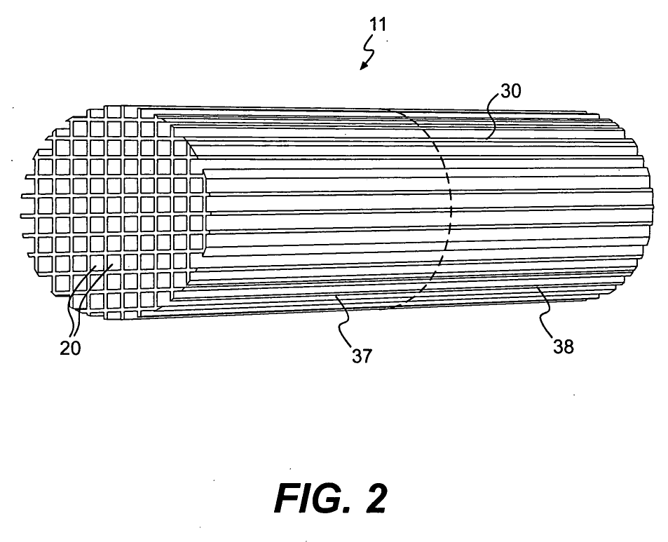

FIG. 2 illustrates exhaust treatment element 11 according to an exemplary embodiment of the invention. Exhaust treatment element 11 may be cylindrical, as shown, or any other suitable shape depending on a particular application. A plurality of channels 20 may be formed in exhaust treatment element 11. Channels 20 may extend through the entire length of exhaust treatment element 11 and allow the passage of exhaust stream 12 through exhaust treatment element 11. Further, catalyst components that may aid in the conversion of NOx in exhaust stream 12 may be deposited on the walls of channels 20. Exhaust treatment element 11 may include a substrate 30 with channels 20 extending therethrough in a honeycomb pattern. The term “honeycomb,” as used herein, may refer to a structure in which channels 20 have cross sections that are hexagonal, rectangular, square, circular, or any other shape. Substrate 30 may be a ceramic or metallic substrate and may include at least one of alumina, cordierite, titania, and FeCr. Other materials, however, may also be used to form substrate 30.

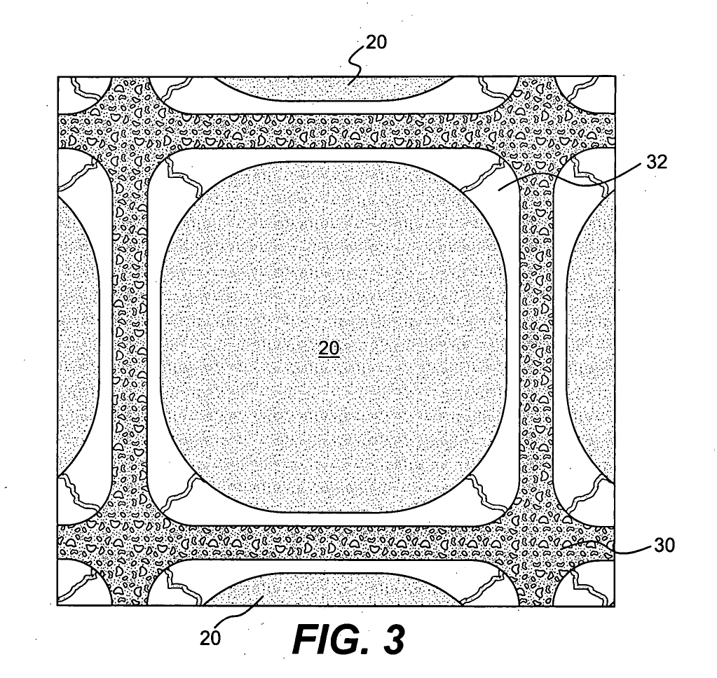

FIG. 3 provides a diagrammatic partial cross-sectional, magnified view (i.e., looking at substrate 30 primarily through a single channel 20) of one embodiment of exhaust treatment element 11. A series catalyst system 32 may be formed on substrate 30. Series catalyst system 32 may include two or more catalysts of differing material composition formed on separate regions of substrate 30. For example, in one exemplary embodiment, series catalyst system 32 may include a first catalyst disposed on a first region 37 (FIG. 2) of substrate 30. Series catalyst system 32 may also include a second catalyst disposed on a second region 38 (FIG. 2) of substrate 30. When exhaust treatment element 11 is placed in exhaust stream 12, first region 37 may be located in exhaust stream 12 in a position upstream with respect to second region 38, for example.

The first catalyst located in region 37 may include metal catalytic promoters such as, for example, tin, indium, gallium, germanium, molybdenum, vanadium, or any combination thereof, dispersed within a catalyst support material. Any other promoter that exhibits catalytic chemical behavior (e.g., partial oxidation of hydrocarbons) to the materials listed may also be used in the first catalyst in region 37. The catalyst support material may include, for example, at least-one of γ-alumina, zeolite, aluminophosphates, hexaluminates, aluminosilicates, zirconates, titanosilicates, and titanates. In one exemplary embodiment, the first catalyst may include tin dispersed within the catalyst support material in an amount of about 5% to about 15% by weight. In certain embodiments, the catalyst support material may be γ-alumina, and the tin may be included in the first catalyst in an amount of about 9% to about 11% by weight.

In one embodiment, the second catalyst disposed in region 38 may include a metal catalytic promoter (e.g., silver, silver oxide, silver nitrate, or any other material that exhibits catalytic behavior similar to silver) dispersed within a catalyst support material. The catalyst support material may include at least one of γ-alumina, zeolite, aluminophosphates, hexaluminates, aluminosilicates, zirconates, titanosilicates, and titanates. The silver may be included in the second catalyst in an amount of about 0.5% to about 4% by weight. In certain embodiments, the catalyst support material may be γ-alumina, and the silver may be included in the second catalyst in an amount of about 1.5% to about 2.5% by weight.

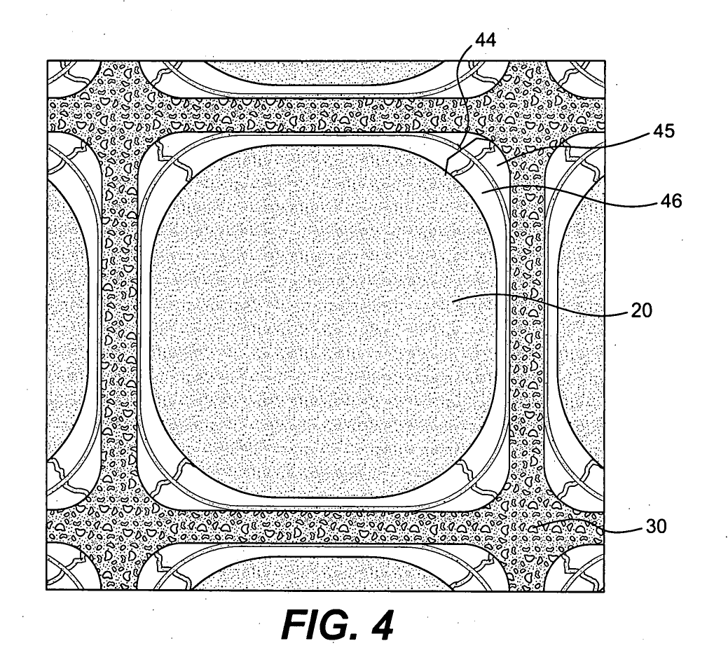

Another embodiment of the invention may include two or more catalyst layers formed on substrate 30, where each layer includes a different material composition. FIG. 4 provides a partial cross-sectional, magnified view (i.e., looking at substrate 30 primarily through a channel 20) of one embodiment of a layered catalyst system 44. For example, in one exemplary embodiment, a layered catalyst system 44 may include a first catalyst layer 45 disposed on substrate 30. Layered catalyst system 44 may also include a second catalyst layer 46 disposed on first catalyst layer 45. First catalyst layer 45 may cover substantially all of substrate 30, or any portion thereof, and second catalyst layer 46 may cover at least a portion of first catalyst layer 45.

In one embodiment of the invention, first catalyst layer 45 may include silver, silver oxide, silver nitrate, or any other material that exhibits catalytic behavior similar to silver, dispersed within a catalyst support material. The catalyst support material may include at least one of γ-alumina, zeolite, aluminophosphates, hexaluminates, aluminosilicates, zirconates, titanosilicates, and titanates. The silver may be included in first catalyst layer 45 in an amount of about 0.5% to about 4% by weight. In certain embodiments, the catalyst support material may be γ-alumina, and the silver may be included in first catalyst layer 45 in an amount of about 1.5% to about 2.5% by weight.

Second catalyst layer 46 may include metal catalytic promoters such as, for example, tin, indium, gallium, germanium, molybdenum, vanadium, any combination thereof, and any other materials exhibiting similar catalytic chemical behavior, dispersed within a catalyst support material. The catalyst support material may include, for example, at least one of γ-alumina, zeolite, aluminophosphates, hexaluminates, aluminosilicates, zirconates, titanosilicates, and titanates. In one exemplary embodiment, second catalyst layer 46 may include tin dispersed within the catalyst support material in an amount of about 5% to about 15% by weight. In certain embodiments, the catalyst support material may be γ-alumina, and the tin may be included in second catalyst layer 46 in an amount of about 9% to about 11% by weight.

Preparation of exhaust treatment element 11 may be accomplished in a variety of ways. An alumina honeycomb or cordierite substrate 30 may be supplied, and the catalysts of series catalyst system 32 and the catalyst layers of layered catalyst system 44 may be formed on substrate 30 using a washcoating technique, for example. As noted above, the catalysts of catalyst systems 32, 44 can include at least two components; i.e., a catalyst support material and a metal promoter. In one embodiment, the catalyst support material may be loaded with the metal promoter prior to the washcoating process. Alternatively, in another embodiment, the catalyst support material may be washcoated without first being loaded with the metal promoter. For example, the metal promoter may be loaded into the catalyst support material after the catalyst support material has already been deposited.

The catalyst support material may be formed using a variety of techniques. For example, powders of γ-alumina, zeolite, aluminophosphates, hex aluminates, aluminosilicates, zirconates, titanosilicates, titanates, or any other suitable catalyst support material may be produced using sol gel, incipient wetness, or precipitation techniques.

The catalyst support material in powder form may be dispersed in a solvent including water, for example, to form a slurry. Other solvents may be used depending on the requirements of a particular application. This slurry can be used in a washcoating process to deposit the catalyst support material onto a selected surface (e.g., substrate 30 and/or first catalyst layer 45). Specifically, the slurry may be applied to the surface in such a way that at least some of the catalyst support material in the slurry may be transferred to the selected surface. In one embodiment, the selected surface may be fully or partially immersed in the slurry. Alternatively, the slurry may be applied to the selected surface by brushing, spraying, wiping, or any other suitable method. After applying the slurry containing the catalyst support, the slurry may be allowed to dry leaving the catalyst support material deposited on the selected surface.

Loading of a metal promoter into the catalyst support material may be accomplished using, for example, an incipient wetness impregnation technique. Other techniques for dispersing the metal promoter material in the catalyst support material, however, may also be suitable. In the incipient wetness technique, the catalyst support material may be brought into contact with a slurry of the metal promoter by, for example, full or partial immersion in the metal promoter slurry. Alternatively, the metal promoter slurry may be applied by brushing, spraying, wiping, dripping, or any other suitable technique. In one embodiment of the invention, the amount of metal promoter slurry applied to the catalyst support material may be equal to or greater than a total pore volume of the catalyst support material.

Where the catalyst support material has not yet been deposited on a selected substrate, the catalyst support material, by itself, may be contacted with the metal promoter slurry. For example, a pipette may be used to introduce the metal promoter slurry to the catalyst support material. A ball mill may also be used to promote homogeneous mixing of the catalyst support material and the metal promoter slurry.

The metal promoter slurry may be formed by dissolving a metal precursor into a solvent such as water, for example. In one embodiment of the invention, the metal promoter may be silver or tin, and the metal precursors may include tin or silver nitrates, acetates, chlorides; carbonates, sulfates, or any other suitable precursors. Contacting the catalyst support material with the metal promoter slurry may have the effect of dispersing the metal promoter, e.g., tin or silver, into the catalyst support material.

Exhaust treatment element 11 may be subjected to additional processing steps including, for example, drying and/or calcining to remove volatile components. Drying may include placing exhaust treatment element 11 in a furnace at a particular temperature and for a particular amount of time. For example, exhaust treatment element 11 may be dried at a temperature of from about 100° C. to about 200° C. for several hours. Calcining may proceed for several hours at temperatures of greater than about 500° C. It will be appreciated that any particular time-temperature profile may be selected for the steps of drying and calcining without departing from the scope of the invention.

Exhaust treatment element 11 may aid in the reduction of NOx from exhaust stream 12 (FIG. 1). The lean-NOx catalytic reaction is a complex process including many steps. One of the reaction mechanisms, however, that may proceed in the presence of exhaust treatment 11 can be summarized by the following reaction equations:
NO+O₂→NOx (1)
HC+O₂→oxygenated HC (2)
NOx+oxygenated HC+O₂→N₂+CO₂+H₂O (3)

The catalyst of region 37 (FIG. 2) and second catalyst layer 46 (FIG. 4), which may include tin dispersed within a catalyst support material, may catalyze the reaction of equation (2). Specifically, the presence of tin in these catalysts may aid in the reformation of hydrocarbon reducing agents to produce activated, oxygenated hydrocarbons such as aldehyde and acrolein. Ultimately, these oxygenated hydrocarbons may combine with NOx compounds to form organo-nitrogen containing compounds. Over a silver containing catalyst, such as first catalyst layer 45, these materials may decompose to isocyanate (NCO) or cyanide groups and eventually yield nitrogen gas (N₂) through a series of reactions, which are summarized by equations (1)-(3).

The catalyst of region 38 (FIG. 2) and first catalyst layer 45 (FIG. 4), which may include silver dispersed within a catalyst support material, may catalyze the reduction of NOx to N₂ gas, as shown in equation (3). The multi-part catalyst systems 32, 44 of the present invention may exhibit a synergistic effect derived from its components. For example, the tin-containing catalyst can promote the formation of oxygenated hydrocarbons, which are consumed in the reaction catalyzed by the silver-containing catalyst. Thus, the catalyst components of multi-part catalyst systems 32, 44 can work together to increase the efficiency the NOx reduction reaction.

While not necessary, a supplemental hydrocarbon reductant may be introduced into exhaust stream 12 (FIG. 1) in order to aid in the production of oxygenated hydrocarbons, as represented by equation (2). Supplemental reductants may include propene, ethanol, diesel fuel, or any other suitable compounds. As illustrated in FIG. 1, exhaust system 10 may include a fluid inlet 16 disposed on exhaust conduit 13 for introducing a supplemental reductant. Further, the supplemental reductant may be stored in a reservoir 17. In one embodiment of the invention, a supplemental reductant consisting of diesel fuel may be supplied to exhaust stream 12. In this embodiment, reservoir 17 may coincide with the fuel tank of a vehicle.

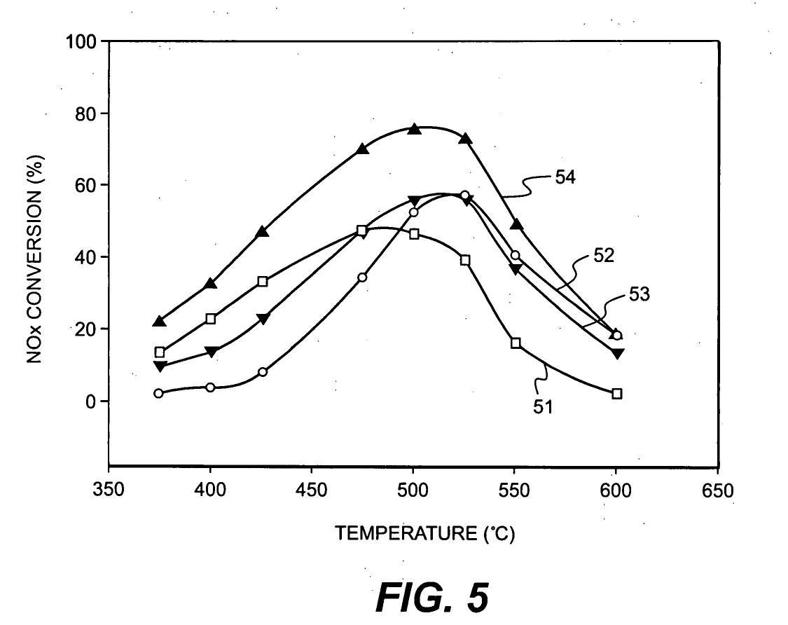

FIG. 5 is a graph that plots NOx conversion % as a function of temperature for NO reduction over various catalysts. Curve 51 includes data for a catalyst of 10% tin by weight dispersed in alumina; Curve 52 includes data for a catalyst of 2% silver by weight dispersed in alumina; Curve 53 includes data for a catalyst formed by physically mixing 10% tin and 2% silver by weight in an alumina support material; Curve 54 includes data for one embodiment of the multi-part catalyst system of the present invention (e.g., one catalyst component including 10% by weight of tin dispersed in alumina and a separate catalyst component including 2% by weight of silver dispersed in alumina). The exhaust stream flowed over each of the catalysts included 0.1% NO, 0.1% propene, 9% O₂, and 7% H₂O at a space velocity of 30,000 h⁻¹. As shown in FIG. 5, the NO conversion efficiency of the multi-part catalyst system (Curve 54) is significantly higher than the single component catalysts (Curve 51 and Curve 52) or the physical mixture catalyst (Curve 53).

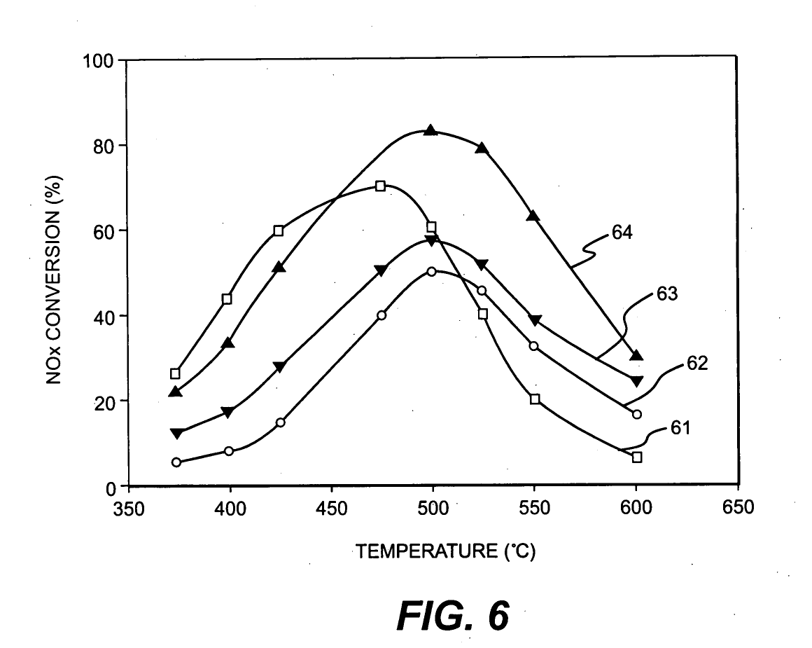

FIG. 6 is a graph that plots NOx conversion % as a function of temperature for NO₂ reduction over various catalysts. Curve 61 includes data for a catalyst of 10% tin by weight dispersed in alumina; Curve 62 includes data for a catalyst of 2% silver by weight dispersed in alumina; Curve 63 includes data for a catalyst formed by physically mixing 10% tin and 2% silver by weight in an alumina support material; Curve 64 includes data for one embodiment of the multi-part catalyst system of the present invention (e.g., one catalyst component including 10% by weight of tin dispersed in alumina and a separate catalyst component including 2% by weight of silver dispersed in alumina). The exhaust stream flowed over each of the catalysts included 0.1% NO₂, 0.1% propene, 9% O₂, and 7% H₂O at a space velocity of 30,000 h⁻¹. As shown in FIG. 6, the NO₂ conversion efficiency of the multi-part catalyst system (Curve 64) is significantly higher than the single component catalysts (Curve 61 and Curve 62) or the physical mixture catalyst (Curve 63).

Industrial Applicability

The disclosed multi-part lean-NOx catalyst systems may be useful in any of a wide variety of applications where reduction of NOx from exhaust streams would be desirable. A multi-part lean NOx catalyst may provide a synergy effect in the reduction of NOx compounds. Specifically, the NOx reduction performance of the multi-part catalyst system may be greater than the NOx reduction performance of any of the catalyst components, or mixtures thereof, taken separately. The catalyst systems of the present invention have demonstrated NOx conversion efficiencies for both NO and NO₂ of about 80% or greater.

Further, the disclosed multi-part catalyst systems may offer high deNOx conversion efficiencies and broad operating temperature windows in the presence of various reductants. The catalysts may also exhibit resistance to poisoning or deactivation from the presence of SO₂ in an exhaust stream.

It will be apparent to those skilled in the art that various modifications and variations can be made in the described catalyst systems without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

1. An exhaust treatment element comprising:
a substrate;
a first catalyst layer including a first promoter disposed on the substrate; and
a second catalyst layer including a second promoter disposed on the first catalyst layer.

2. The exhaust treatment element of claim 1, wherein the first promoter includes silver.

3. The exhaust treatment element of claim 2, wherein the silver is dispersed within a catalyst support material in an amount of about 0.5% to about 4% by weight.

4. The exhaust treatment element of claim 3, wherein the catalyst support material includes at least one of γ-alumina, zeolite, aluminophosphates, hexaluminates, aluminosilicates, zirconates, titanosilicates, and titanates.

5. The exhaust treatment element of claim 2, wherein the silver is dispersed within a catalyst support material in an amount of about 1.5% to about 2.5% by weight.

6. The exhaust treatment element of claim 1, wherein the second promoter includes tin.

7. The exhaust treatment element of claim 6, wherein the tin is dispersed within a catalyst support material in an amount of about 5% to about 15% by weight.

8. The exhaust treatment element of claim 7, wherein the catalyst support material includes at least one of γ-alumina, zeolite, aluminophosphates, hexaluminates, aluminosilicates, zirconates, titanosilicates, and titanates.

9. The exhaust treatment element of claim 6, wherein the tin is dispersed within a catalyst support material in an amount of about 9% to about 11% by weight.

10. The exhaust treatment element of claim 1, wherein the second promoter includes at least one of tin, indium, gallium, germanium, molybdenum, and vanadium.

11. The exhaust treatment element of claim 1, wherein the substrate includes one of honeycomb alumina and cordierite.

12. A method of making an exhaust treatment element comprising:
forming a first catalyst layer including a first promoter on a substrate; and
forming a second catalyst layer including a second promoter on the first catalyst layer.

13. The method of claim 12, wherein forming the first catalyst layer further includes:
washcoating the substrate with a slurry that includes a catalyst support material;
transferring at least some of the catalyst support material from the slurry to the substrate; and
dispersing the first promoter within the catalyst support material.

14. The method of claim 12, wherein forming the second catalyst layer further includes:
washcoating the substrate, including the first catalyst layer, with a slurry that includes a catalyst support material;
transferring at least some of the catalyst support material from the slurry to the substrate; and
dispersing the second promoter within the catalyst support material.

15. The method of claim 12, wherein the first catalyst layer covers substantially all of the substrate, and the second catalyst layer covers at least a portion of the first catalyst layer.

16. The method of claim 12, wherein the first catalyst layer includes a catalyst support material including at least one of γ-alumina, zeolite, aluminophosphates, hexaluminates, aluminosilicates, zirconates, titanosilicates, and titanates.

17. The method of claim 12, wherein the second catalyst layer includes a catalyst support material including at least one γ-alumina, zeolite, aluminophosphates, hexaluminates, aluminosilicates, zirconates, titanosilicates, and titanates.

18. The method of claim 12, wherein the first promoter includes silver.

18. The method of claim 18, wherein the silver is included in the first catalyst layer in an amount of about 0.5% to about 4% by weight.

20. The method of claim 18, wherein the silver is included in the first catalyst layer in an amount of about 1.5% to about 2.5% by weight.

21. The method of claim 12, wherein the second promoter includes tin.

22. The method of claim 21, wherein the tin is included in the second catalyst layer in an amount of about 5% to about 15% by weight.

23. The method of claim 21, wherein the tin is included in the second catalyst layer in an amount about 9% to about 11% by weight.

24. The method of claim 12, wherein the second promoter includes at least one of tin, indium, gallium, germanium, molybdenum, and vanadium.

25. The method of claim 12, wherein the substrate includes one of honeycomb alumina and cordierite.

26. An exhaust treatment element comprising:
a substrate having a first region and a second region along its length;
a first catalyst disposed on the first region of the substrate, wherein the first catalyst includes tin dispersed within γ-alumina; and
a second catalyst disposed on the second region of the substrate, wherein the second catalyst includes silver dispersed within γ-alumina.

27. The exhaust treatment element of claim 26, wherein the tin is included in the first catalyst in an amount of about 5% to about 15% by weight

28. The exhaust treatment element of claim 26, wherein the tin is included in the first catalyst in an amount of about 9% to about 11% by weight.

29. The exhaust treatment element of claim 26, wherein the silver is included in the second catalyst in an amount of about 0.5% to about 4% by weight.

30. The exhaust treatment element of claim 26, wherein the silver is included in the second catalyst in an amount of about 1.5% to about 2.5% by weight.

31. A method of making an exhaust treatment element, comprising:
forming a first catalyst on a first region of a substrate, wherein the first catalyst includes tin dispersed within γ-alumina; and
forming a second catalyst on a second region of the substrate, wherein the second catalyst includes silver dispersed within γ-alumina.

32. The method of claim 31, wherein the first region and the second region are located serially along the length of the substrate.

33. The method of claim 31, wherein the tin is included in the first catalyst in an amount of about 5% to about 15% by weight

34. The method of claim 31, wherein the tin is included in the first catalyst in an amount of about 9% to about 11% by weight.

35. The method of claim 31, wherein the silver is included in the second catalyst in an amount of about 0.5% to about 4% by weight.

36. The method of claim 31, wherein the silver is included in the second catalyst in an amount of about 1.5% to about 2.5% by weight.
